(19) United States
(12) Patent Application Publication
(10) Pub. No.: US 2015/0333434 A1
(43) Pub. Date: Nov. 19, 2015

(54) ELECTRICAL CONNECTOR DEVICE

(71) Applicant: DELPHI INTERNATIONAL OPERATIONS LUXEMBOURG S.À.R.L., Luxembourg, Bascharage (LU)

(72) Inventors: ARNAUD DUQUESNE, YERMENONVILLE (FR); GERARD MULOT, NOGENT LE ROI (FR)

(21) Appl. No.: 14/652,932

(22) PCT Filed: Dec. 18, 2012
(86) PCT No.: PCT/IB2012/002968

§ 371 Date: Jun. 17, 2015

(51) Int. Cl. H01R 13/52

(52) U.S. Cl. CPC H01R 13/521

(57) ABSTRACT

The present invention relates to an electrical connector device comprising a terminal carrier including at least one contact cavity having a front stop, a multi-contact rear body having at least one back support , a terminal incorporated in the contact cavity of the terminal carrier and assembled to an electrical wire, and -a sealing member provided in the contact cavity of the terminal carrier. The sealing member extends from the front stop of the contact cavity to the back support of the multi-contact rear body.

### CROSS-REFERENCE TO RELATED APPLICATION

This application is a national stage application under 35 U.S.C. §371 of PCT Application Number PCT/IB2012/002968 having an international filing date of Dec. 12, 2012 which designated the United States, the entire disclosure of which is hereby incorporated herein by reference.

### TECHNICAL FIELD OF THE INVENTION

The present invention relates to an electrical connector device. In particular, it relates to a sealed protection for electrical contacts in an electrical connector assembly.

### BACKGROUND OF THE INVENTION

The protection of electrical contacts is of high importance to avoid undesirable outside effects and to ensure the required operation of the electrical contacts.

Some traditional electrical connector devices comprise a connector body having a plurality of cavities each receiving an electrical contact. The electrical contact is usually provided by assembly of two complementary parts, a terminal and a wire. Such assembly is then fastened to the connector body.

For the terminal and the wire which are parts of the electrical contact, it is necessary to have a protection in the assembly region against moisture, mechanical stress or other unwanted effects. In most of the cases, the electrical contact protection is not satisfactory.

The electrical contact has to be mounted somehow loose in the contact cavity, in order to easily assemble seals to protect the assembly region. Thus, the electrical contacts in the connector body can move during mechanical manipulations, or mating with a mating connector, thereby the electrical contact can be damaged and the quality of the electric connection decreased.

### BRIEF SUMMARY OF THE INVENTION

The present invention aims to solve those drawbacks. For this purpose, it relates to an electrical connector device comprising:
a terminal carrier including at least one contact cavity,
a multi-contact rear body,
a terminal incorporated in the contact cavity of the terminal carrier and assembled to an electrical wire,
a sealing member provided in a contact cavity of the terminal carrier, preferably extending lengthwise from a front opening of the contact cavity to the back support of a multi-contact rear body, unitary sealingly covering the inner space of the contact cavity and thereby encompassing the terminal and the electrical wire in an assembled position.

Hence, the sealing member would cover the terminal in the connector body and also the electrical wire from the mating connector part, thereby covering the whole assembly region without any possible gap. The arrangement of the sealing member could be provided between the terminal and the contact cavity of the terminal carrier, thus the interstice would be filled up so the relative movement of the terminal in the contact cavity could be restricted.

In that improved connector device, a wrong tilted positioning of the electrical contact would be avoided due to the proper sealing settings of the sealing member.

It would be desirable for the electrical contact to have protection on both complementary parts without any intermittence. Sealing from two or more parts are more complicated to implement and the gaps between the sealing parts cannot give fully protection from undesirable effects.

Furthermore, if the electrical contact is effectively sealed, the sealing member can prevent the movement of the electrical contact in the contact cavity of the connector body. The sealing member fills the possible gap between the contact cavity and the terminal in the connector body and the electrical contact, thereby reducing the free space around the terminal, thus preventing it from moving in unwanted position. So, the misalignment of the electrical contact can be reduced.

Furthermore, the improvement would enable better isolation of the connector parts and the assembly region. Another aspect of the invention is to improve the protection of the electrical contact without increasing the contacts cost. Indeed, another drawback of known connector devices is that electrical contacts are rather expensive.

Usually, electrical contacts are produced by bar turning. A copper alloy bar, in which the electrical contact is cut off, has a diameter corresponding to the largest outside diameter of the electrical contact. Therefore, a lot of material to be taken off to get the final electrical contact shape. As the copper alloy cost increases, there is a need for an electrical contact design requesting a smaller bar diameter and less material to be taken off. The above invention provide a solution to this requirement.

In some other embodiments, one might also use one or more of the features as defined in dependent claims. Of course, different features, alternatives and/or embodiments of the present invention can be combined with each other in various arrangement to the extent that they are not incompatible or mutually exclusive of others.

### BRIEF DESCRIPTION OF THE SEVERAL VIEWS OF THE DRAWING

The present invention will now be described, by way of example with reference to the accompanying drawings, in which:

FIG. 1 is a front side perspective view of an electrical connector device according to the present invention,

FIG. 2 is a cut section view of the electrical connector device of FIG. 1, and

FIG. 3 is a perspective view of a terminal according to the present invention.

It should be noted that, on figures, structural and/or functional elements which are common to different embodiments may have the same reference sign. Thus, unless otherwise stated, these elements have structural, dimensional and material properties which are identical.

### DETAILED DESCRIPTION OF THE INVENTION

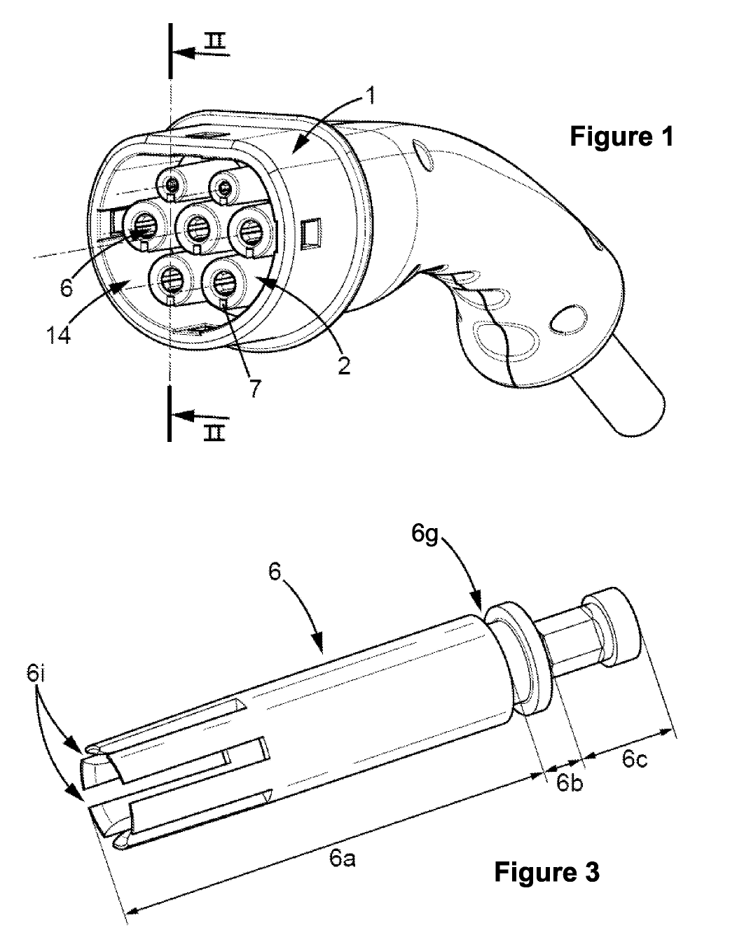

FIG. 1 is a front side perspective view of an electrical connector device according to the present invention. The electrical connector device comprises a terminal carrier 1 with an outside frame which encompasses a plurality of terminal holders 2 with contact cavities and a peripheral cavity 14 in which are located the terminal holders 2. Contact cavities and the peripheral cavity 14 are open to the front side of the electrical connector device in order to receive a complementary part of a corresponding connector.

The contact cavity comprises a front opening 15a on the front side of the electrical connector device. In addition, the contact cavity also comprises a rear opening 15b which is facing the front opening 15a of the terminal holder 2. The front opening 15a and the rear opening 15b are determining the extension of the contact cavity. Moreover, the contact cavity comprises an inner wall 16 arranged between the front opening 15a and the rear opening 15b. Advantageously, the contact cavity is a tubular shaped channel.

Terminal holders 2 are cylindrically shaped and protruding to the front side, according to the assembling direction. Furthermore, each terminal holder 2 is defined by the inner wall 16 and an outer wall 17. In addition, each terminal holder 2 may comprise a flange 18, arranged in the front side of the electrical connector device. The flange 18 surrounds the front opening 15a.

In addition, according to a particular embodiment of the present invention, each terminal holder 2 also comprises a recess 7 in the front opening 15a. Preferably, the recess 7 extends inwardly from the front side of the terminal holder 2. Particularly, the recess 7 has an inverse U-shape extending inwardly.

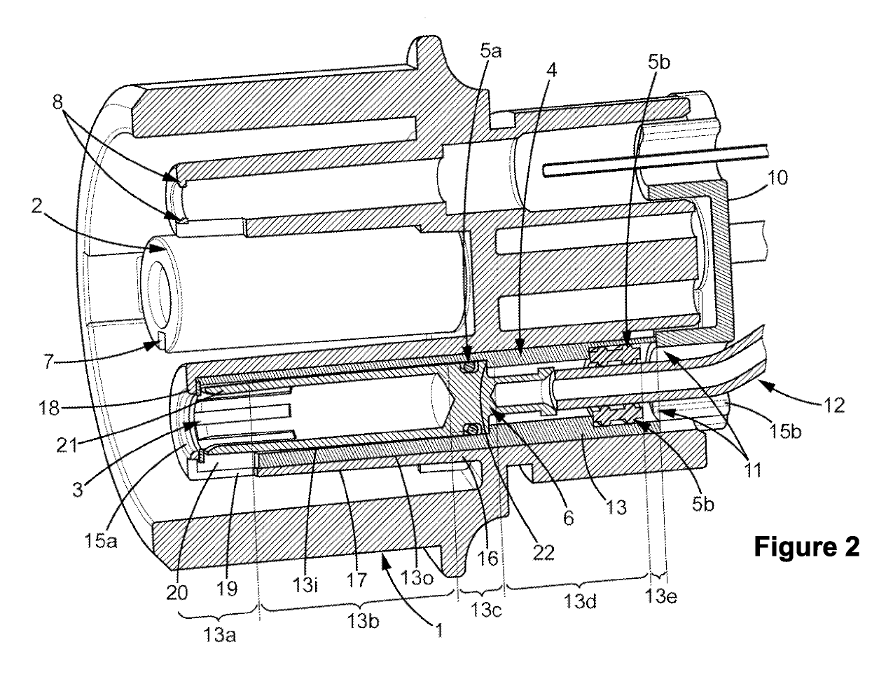

From the front side of the terminal holder 2, in particular from the flange 18 of the terminal holder 2, the depth of the recess 7 increases to the inner wall 16 of the terminal holder 2. Consequently, the recess 7 creates a hole 19 in the terminal holder 2. The hole 19 is more visible on FIG. 2, which is a cut section view of the electrical connector device of FIG. 1.

Advantageously, the recess 7 aims to evacuate water out of the contact cavity.

The flange 18 has an outer dimension which is in accordance with the dimension of an outer wall 17 of the terminal holder 2. In addition, an inner dimension of the flange 18 is not in accordance with the inner dimension of the terminal holder 2. More precisely, an inner radius of the flange 18 is smaller and, thereby, peripherally protruding from the wall of the terminal holder 2.

The flange 18 defines a front stop 8 for any elements arranged inside of the contact cavity, for example a terminal 6 arranged inside the contact cavity.

In addition, a sealing member 4 is arranged inside the contact cavity. Optionally, the contact cavity may comprise a front stop member 3. Advantageously, the terminal 6 and the sealing member 4 are firmly assembled together.

The front stop member 3 consists of a collar shaped circular base with a plurality of projections from the collar shaped circular base. The front stop member 3 is a stop in the contact cavity for the terminal holder 2 preventing the terminal 6 from moving forward.

The front stop member 3 is optional since there is the front stop 8 on the terminal holder 2 to prevent the sealing member 4 from moving forward, the terminal 6 and the sealing member 4 being firmly assembled to one another.

FIG. 3 is a perspective view of the terminal 6 according to the present invention. The terminal 6 is integrated into the contact cavity.

The terminal 6 comprises a front tubular portion 6a, a central portion 6b and a rear tubular portion 6c.

The front tubular portion 6a is facing the front side of the terminal holder 2 and is configured to mate an electrical contact of a complementary electrical connector.

The front tubular portion 6a comprises an outer wall and an inner wall. The outer wall of the front tubular portion 6a is accommodated to the inner wall of the contact cavity. Moreover, the outer wall of the front tubular portion 6a is accommodated to the sealing member 4, while the inner wall is accommodated to mate a terminal 6 of a complementary electrical connector.

The front tubular portion 6a comprises a hollow formed by the inner wall of the front tubular portion 6a.

Preferably, the front tubular portion 6a is conically narrowing from the front opening 15a towards the central portion 6b. Afterwards, the hollow comprises a part extending constantly and, by approaching the central portion 6b, the front tubular portion 6a is again conically narrowing.

In addition, the front tubular portion 6a may comprise at least one notch 6i to allow deflection of elastic legs 21 upon insertion of the mating terminal.

The central portion 6b of the terminal 6 comprises a peripheral groove 6g. A front annular seal 5a can be introduced in the peripheral groove 6g of the central portion 6b of the terminal 6. The front annular seal 5a can be of any shape. Preferably, the front annular seal 5a is a ring with circular cross-section, such as an O-ring.

The rear tubular portion 6c of the terminal 6 is facing the rear opening 15b of the contact cavity. The rear tubular portion 6c of the terminal 6 is configured to be assembled with an electrical wire 12 of an electrical cable.

For the electrical wire 12 of the electrical cable, a rear annular seal 5b is provided on the electrical wire 12. Preferably, the rear annular seal 5b comprises a ring shaped main body and protruding portions. Protruding portions of the rear annular seal 5b are opposite each other on the inner side and the outer side of the ring shaped main body of the rear annular seal 5b.

The rear tubular portion 6c also comprises an outer wall and an inner wall. The outer wall of the rear tubular portion 6c is accommodated to the inner wall of the contact cavity and to the sealing member 4, while the inner wall is accommodated to receive an electrical wire 12.

The rear tubular portion 6c comprises a hollow formed by the inner wall of the rear tubular portion 6c, which is conically broadening from the central portion 6b towards the rear opening 15b of the contact cavity.

Afterwards, the hollow formed by the inner wall of the rear tubular portion 6c is extending constantly and, by approaching the rear opening 15b of the rear tubular portion 6c, the hollow is conically broadening towards the rear opening.

Furthermore, a rear collar portion is covering the a opening of the rear tubular portion 6c, visible on FIG. 2. The rear collar portion is covering a region of the rear tubular portion 6c which starts before the conically broadening towards the rear opening 15b and ends at the rear opening of the rear tubular portion 6c. This hollow shaft is assembled to an end of the electrical wire 12, for example by crimping.

The sealing member 4 is integrated in the contact cavity of terminal carrier 1 and unitarily extends from the front stop 8 of the contact cavity to a back support 11 of a multi-contact rear body 10, which is inserted in arear side of the terminal carrier 1.

The sealing member 4 comprises a tube 13, preferably a cylindrically shaped rigid tube 13. The tube 13 comprises an inner wall 13i and an outer wall 130.

The outer wall 130 is accommodated to the inner wall of the contact cavity and the inner wall 13i is accommodated to the inner elements of the contact cavity, namely to:
the optional front stop member 3,
the terminal 6, more precisely to the front tubular portion 6a, the central portion 6b and the rear tubular portion 6c of the terminal 6,
the front annular seal 5a and the rear annular seal 5b, and
the electrical wire 12.

Thus, the sealing member 4, made of the assembly of the tube 13 and the front annular seal 5a and the rear annular seal 5b, is configured to unitarily and sealingly cover the aforesaid connection region of the terminal 6 and of the electrical wire 12 in the contact cavity.

Namely, the thickness of the tube 13 is varying, so the inner wall of the tube 13 has incisions to accommodate the front stop member 3, the front tubular portion 6a of the terminal 6, the central portion 6b of the terminal 6, the rear tubular portion 6c of the terminal 6, the front annular seal 5a, the rear annular seal 5b and the electrical wire 12.

Therefore, the tube 13 has:
an optional front stop member covering section 13a,
a terminal covering section 13b, which preferably includes a front tubular portion covering section,
a central portion covering section, a rear tubular portion covering section,
a front annular seal covering section 13c,
a rear annular seal covering section 13d, and
an electrical wire covering section 13e, arranged one after one another along a longitudinal axis.

Therefore, the tube 13 is preferably covering respectively the front tubular portion 6a of the terminal 6, the front annular seal 5a, the rear annular seal 5b and a portion of the electrical wire 12.

The terminal covering section 13b serves as a support for the elastic legs 21 of the terminal 6 and prevents any/excessive deflection thereof. The tube 13 further comprises a hole 20, facing the hole 19 in the terminal holder 2.

The tube 13 presses the front annular seal 5a in contact with the terminal 6 inside the peripheral groove 6g.

Moreover, the contact cavity further comprise the electrical wire 12. The electrical wire 12 might be carried by the multi-contact rear body 10, able to be assembled to the rear tubular portion 6c of the terminal 6 inside the contact cavity. In an assembled position, when the electrical wire 12 mates the rear tubular portion 6c through the rear opening of the contact cavity, the rear annular seal 5b is pressed on the electrical wire 12.

Moreover, the tube 13 is also pressing the rear annular seal 5b and the electrical wire 12, rearward from the assembly region of the electrical wire 12 with the terminal 6.

The multi-contact rear body 10 comprises at least one back support 11, preferably a plurality of back supports 11, able to accommodate corresponding openings on a terminal carrier 1 and, thereby, forming a rear stop for tubes 13 in a terminal carrier 1.

In the same way, the multi-contact rear body 10 also carries electrical wires 12, which are surrounded by the back support 11, and the back support 11 are also supporting the electrical wires 12.

The electrical connector which has just been described can be assembled as follows:
on the one hand, the terminal carrier 1 is provided, and on the other hand, one provides an electrical cable having at least one electrical wire 12,
the electrical wire 12 is slid through respective an opening of the multi-contact rear body 10,
a rear annular seal 5b is slid backward from the front end of the electrical wire 12,
a tube 13 is slid backward from the front end of the electrical wire 12,
the front end of the electrical wire 12 is assembled, for example by crimping, to a terminal 6,
a front annular seal 5a is placed in a peripheral groove 6g of the terminal 6,
the tube 13 is slid frontward to cover the terminal 6, until it abuts on a rear stop 22 of the terminal 6,
if necessary, the tube 13 is rotated about its longitudinal axis, so that a hole 19 of the terminal holder 2 and a hole 20 of the tube 13 will face one another,
the rear annular seal 5b is slid frontward inside the tube 13,
the assembly region between the terminal 6 and the electrical wire 12 is sealed by the front annular seal 5a and the rear annular seal 5b pressing on the inner face of the tube 13,
the tube 13, carrying the terminal 6, the front annular seal 5a and the rear annular seal 5b, is slid frontward into the terminal cavity, until it abuts on a front stop 8 of the terminal carrier 1,
the tube 13 is tightly fitted in the terminal cavity, in order to reduce, as much as possible, an angle between the longitudinal axis of the terminal 6 and the longitudinal axis of the tube 13.

The multi-contact rear body 10 is moved frontward and assembled to the terminal carrier 1, for example by snap-fitting, in a position where the back support 11 abuts on the rear end of the tube 13. This way, the tube 13 and, hence, the terminal 6 are retained in the terminal carrier 1.

When a mating connector is assembled to the above described electrical connector, the male pin will deflect the elastic legs 21 of the terminal 6. The elastic leg 21 will however be supported by the tube 13, which will prevent any too high deflection from the elastic legs 21, and, hence, reduce any possible damage to the elastic legs 21.

The terminal 6 is quite tightly fitted into the tube 13, since the front most contact region between the terminal 6 and the tube 13 will be the deflected elastic leg 21, and the rearmost contact region between the terminal 6 and the tube 13 will be the rear annular seal 5b. Thus, the terminal 6 cannot tilt much within the tube 13 with respect to the longitudinal axis of the tube 13. The tube 13 may move slightly inside the contact cavity to accommodate for the introduction of the terminal.

Obviously, the present invention is not limited to embodiments which are here above described and provided only as examples. It also includes different modifications, and alternatives that may be considered by the person skill in the art as part of the present invention, including all combinations of different embodiments here above described, taken alone or in combination.

1. An electrical connector device., comprising:
a terminal carrier including a contact cavity having a front stop;
a multi-contact rear body having a back support;
a terminal incorporated in the contact cavity of the terminal carrier, wherein the terminal is assembled to an electrical wire; and
a sealing member provided in the contact cavity of the terminal carrier wherein the sealing member extends lengthwise from the front stop of the contact cavity to the back support of the multi-contact rear body unitarily sealingly covering an assembly region of the terminal and the electrical wire.

2. The electrical connector device according to claim 1, wherein the sealing member comprises a tube.

3. The electrical connector device according to claim 2, wherein a front annular seal is interposed between the tube and the terminal.

4. The electrical connector device according to claim 2, wherein a rear annular seal is interposed between the tube and the electrical wire.

5. An electrical connector device comprising:
a terminal carrier including a contact cavity having a front stop;
a multi-contact rear body having a back support;
a terminal incorporated in the contact cavity of the terminal carrier, wherein the terminal is assembled to an electrical wire; and
a sealing member provided in the contact cavity of the terminal carrier, the sealing member further comprising:
a tube extending lengthwise from the front stop of the contact cavity to the back support of the multi-contact rear body,
a front annular seal being interposed between the tube and the terminal, frontward of an assembly region of the terminal and the electrical wire, and
a rear annular seal being interposed between the tube and the electrical wire rearward of the assembly region of the terminal and the electrical wire, the sealing member unitarily sealingly covering the assembly region of the terminal and the electrical wire.

6. The electrical connector device according to claim 5, wherein the rear annular seal comprises a ring shaped main body and protruding portions and the protruding portions are opposite each other on the inner and outer side of the ring shaped main body.

7. The electrical connector device according to claim 2, wherein the tube further comprises:
a terminal covering section,
a front annular seal covering section,
a rear annular seal covering section, and
an electrical wire covering section, provided one after another along a longitudinal axis of the tube.

8. The electrical connector device according to claim 2, wherein the tube further comprises an inner wall configured to the terminal and an outer wall configured to an inner wall of the contact cavity.

9. The electrical connector device according to claim 7, wherein the tube further comprises an inner wall and an outer wall, and wherein a thickness defined by a distance between the inner wall and the outer wall of the tube is varying according to the terminal and the inner wall of the contact cavity.

10. The electrical connector device according claim 1, wherein a front stop member is integrated into the contact cavity as the front stop for the terminal.

11. The electrical connector device according to claim 1, wherein the terminal further comprises:
a front tubular portion,
a central portion, and
a rear tubular portion provided one after another along a longitudinal axis of the terminal.

12. The electrical connector device according to claim 1, wherein the multi-contact rear body is configured to mate the rear opening of the contact cavity, a rear annular seal member and a rear tubular portion of the terminal.
